(19) United States
(12) Patent Application Publication
(10) Pub. No.: US 2005/0025873 A1
(43) Pub. Date: Feb. 3, 2005

(54) Baked goods having extended shelf life

(76) Inventor: Calvin F. Konzak, Pullman, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/484,028

(22) PCT Filed: May 16, 2002
(86) PCT No.: PCT/US02/15674

Related U.S. Application Data
(60) Provisional application No. 60/295,085, filed on May 31, 2001.

(51) Int. Cl. A21D 2/00

(52) U.S. Cl. 426/622

(57) ABSTRACT

In one aspect, the present invention provides partially waxy wheat flour comprising starch comprising amylose in an amount of from 10 weight percent to 20 weight percent, and amylopectin in an amount less than 90%. In another aspect, the present invention provides flour blends comprising one or more partially waxy wheat flours of the invention. The present invention also provides baked goods prepared from a flour or flour blend of the invention. The baked goods of the invention possess an extended shelf life. In other aspects, the present invention provides methods for making baked goods.

### FIELD OF THE INVENTION

The present invention relates to partially waxy wheat flour, to flour blends that include partially waxy wheat flour, and to baked goods made from partially waxy wheat flour. The baked goods possess an extended shelf life.

### BACKGROUND OF THE INVENTION

Edible baked goods, such as bread, bagels, raised doughnuts, cakes, and other baked products can be made from flour prepared from the seeds of common, hexaploid wheats, although a lower proportion of flours from a wide variety of other cereals, including oats, barley, millet and rye, are often included to obtain products with different flavors, or with more fiber, but most baked goods are prepared from wheat flour, because wheat is unique among cereals for its content and composition of gluten protein. Gluten is comprised of two types of proteins, gliadins and glutenins, which together are responsible for the dough-forming properties of wheat flours. Wheat flour is made by milling wheat seeds, which are sometimes referred to as wheat grains or wheat kernels, and the seed coat is commonly separated as part of the bran, from the endosperm, to make flour. Wheat seeds include an outer, protective, seed coat, which along with the outer layers of endosperm cells, the aleurone layer, make up the bran portion, an embryo (usually called the wheat germ) and starchy endosperm that provides food for the embryo which develops from these. The endosperm makes up more than 80% of the weight of a wheat grain seed and typically contains from 62-67% starch and about 11% gluten protein. Gluten protein is the principal protein component of the endosperm. Wheats are divided into two main classes—hard and soft, and within these, varieties differ by the color of their seed coat, as hard or soft ‘red’ or hard or soft ‘white’ Market Classes. The soft varieties yield flours that are often relatively low in protein content, and usually have weaker mixing strength gluten proteins, while the hard endosperm varieties usually are selected to yield flours that are relatively higher in gluten having stronger mixing properties, but those relationships are more traditional than necessary, since soft wheat varieties with the stronger proteins required for bread making can easily be developed by recombination breeding.

The core ingredients that are used to make baked goods are flour and water. Usually salt, and a leavening agent, such as yeast, are also added. Additional ingredients can include sugar, eggs, butter and fruits. For example, when making bread from wheat flour, salt, water and yeast, the ingredients are mixed to yield a dough that is sufficiently strong and extensible to rise as gas is produced by yeast fermentation during the dough-development, proofing, and baling processes, and that provides a sponge-like network or matrix stable enough to hold the starch and to contribute support to the crumb structure when baking is complete. The amount and composition of gluten proteins in wheat flours are mainly responsible for the spongy network (matrix) developed in wheat flour doughs. The spongy-network of doughs is formed during the dough-mixing process, and during the fermentation process, the gluten matrix traps the gas bubbles formed by the yeast, resulting in the dough expansion (rising). Then, the dough is shaped into subunits, which are allowed to rise for a short period (proofing), then are baked. During the fermentation process the yeast grow and convert carbohydrates (sugars) to ethanol and carbon dioxide. The sugars, usually sucrose, may be added as such, and/or malt (containing amylases) often may be added to convert some of the starches to sugars, which then are metabolized by the yeast. During baking, the gases formed by the yeast inside the dough expand, causing the dough to rise further, most of the alcohol evaporates, and the starch granules begin to swell after about 60° C. is reached. In the presence of water, the starch gelatinizes, forming a thick paste within the protein matrix. The amylose molecules in the starch paste phase separate from the amylopectin molecules, and during cooling after baking, the amylose molecules retrograde (recrystallize) within the gluten protein matrix, to form the crumb structure of the baked product. At about 74° C., the gluten matrix is denatured, contributing further strength to the crumb structure. However, the main contributor supporting the crumb structure of baked bread is retrograded amylose.

Instead of using yeast as a leavening agent, some baked goods can be leavened with chemicals that produce carbon dioxide. A commonly used leavening agent is baking powder, which includes sodium bicarbonate and an acid salt, such as Cream of Tartar (potassium bitartrate). Some baked goods are unleavened, such as unleavened, flat, or pita breads.

It is common knowledge that baked goods, such as bread and cakes, lose moisture, and harden rapidly during storage after baking. This process is commonly referred to by the baking industry as “staling”. Staling reduces the consumer appeal of the baked goods, which are then difficult to sell. The staling process is accelerated at refrigerator temperatures of about 4-5° C., as is the retrogradation of starch molecules of the gel/paste formed during baking.

Although baked goods can become stale due to infection by molds, staling usually results from starch retrogradation, or the reduction of starch solubility. Retrogradation is the process by which starch molecules associate with each other, and recrystallize after baking. When starch is cooked, its granular structure is changed, and all of the crystalline structures of the starch granules are degraded. During storage after baking, the amylopectin molecules in the crumb gradually retrograde, and this process is believed to cause the baked goods to “stale”. Emulsifiers, such as monoglycerides, calcium and sodium steroyl lactate are often used as softeners in breads to delay staling, but they have limited effectiveness.

Starch is composed both of linear amylose molecules and branched amylopectin molecules. Wheat starch typically contains about 25-28% amylose and about 72-75% amylopectin. Amylopectin absorbs and retains water more strongly than amylose, presumably because of the branched molecular structure of amylopectin. Consequently, attempts have been made to reduce the staling rate of baked goods by increasing the amount of amylopectin starch. For example, flour blends have been prepared in which some wheat flour is replaced with waxy barley flour, which does not include amylose. Gluten protein must be added, however, to compensate for the reduction in protein caused by the substitution of wheat flour by the waxy barley flour, which does not contain gluten.

Wheat mutants exist, which when recombined, produce fully waxy grains that comprise starch containing very little, or no amylose (usually 0-4%). These mutant-derived grains are termed waxy, because of the waxy appearance of their grains. However, the term is a misnomer, since the trait has no relation to plant waxes for which the same term is used. Cultivated wheat plants are polyploids, i.e., possess two or three sets of chromosomes, and the so-called common, or ‘bread’ wheats are hexaploid (having three sets of chromosomes). The amylopectin debranching enzyme protein, granule-bound starch synthase (GBSS), encoded in each set of chromosomes may be functionally inactive, due to a deleted gene, to a DNA base alteration, or to mutation-induced reduction in the activity of the GBSS enzyme, causing the enzyme to be partially active, or inactive, in waxy mutants.

Although waxy grains contain elevated levels of amylopectin, which binds water better than amylose and would therefore be expected to retard the staling process, bread made from the flour of fully waxy wheats, or induced mutant waxy wheats, does not possess reduced staling characteristics. Indeed, bread made from waxy wheat flour is filled with large, open spaces, due to the absence of amylose molecules, which normally form the crumb structure, and the crumb texture is soggy due to the retention of too much water by the amylopectin starch.

The present inventor has developed novel, partially waxy wheat genetic recombinant selections, which produce starch with less amylose than non-waxy wheat (i.e., wheat, in which all of the GBSS genes produce fully functional GBSS enzyme proteins), but more amylose than fully waxy wheats (i.e., wheats that do not produce any GBSS protein, or which produce one or more, non-functional, or less functional GBSS proteins). In one embodiment of the invention, partially waxy wheat plants of the present invention include at least one pair of functional GBSS or Wx genes. Baked goods made from flour obtained from the plants of the present invention possess an extended shelf life, i.e., have a reduced rate of staling. Thus, in one aspect, the present invention provides partially waxy wheat flour, and flour blends, including partially waxy wheat flours, from which baked (or boiled, or fried) goods may be made that have an extended shelf-life, due to their reduced staling properties.

### SUMMARY OF THE INVENTION

In one aspect, the present invention provides partially waxy wheat flour comprising starch comprising amylose in an amount from at least 10% up to 20%, and amylopectin in an amount less than 90%. In some embodiments, the partially waxy wheat flour of the invention comprises starch comprising amylose in an amount of from 15% to 20%, and amylopectin in an amount of from 80% to 85%. In other embodiments, the partially waxy wheat flour of the invention comprises starch comprising amylose in an amount of from 15% to 18%, and amylopectin in an amount of from 82% to 85%.

Some partially waxy wheat flours of the invention further comprise protein in an amount of from 5% to 16%. Typically, the protein content of soft wheat is from 8% to 12%. Typically, the protein content of hard wheat is from 11% to 18%. The prime starch fraction of the partially waxy starch of the partially waxy wheat flours of the invention has a Brabender amylograph peak viscosity temperature of from 93° C. to 96.5° C.

In another aspect, the present invention provides a flour blend comprising one or more partially waxy wheat flours of the invention. The flour blends of the present invention can include a mixture of waxy and/or partially waxy and/or non-waxy flours. In another aspect, the present invention provides baking mixes comprising a partially waxy wheat flour of the invention. The present invention also provides baked goods prepared from a partially waxy wheat flour and/or flour blend and/or baking mix of the invention. The baked goods possess an extended shelf life as described herein.

In another aspect, the present invention provides methods for making baked goods. The methods comprise the steps of (a) preparing a baking mix comprising a partially waxy wheat flour of the invention; and (b) baking the baking mix to form a baked product. In one embodiment, the methods comprise the steps of (a) preparing a baking mix comprising flour consisting of partially waxy wheat flour comprising starch comprising amylose in an amount of from 10% to 20%, and amylopectin in an amount less than 90%; and (b) baking the baking mix to form a baked product. In some embodiments, the flour further comprises protein in an amount of from 5% to 16%.

The flour, flour blends, and baking mixes of the invention are useful, for example, for making baked goods. The baked goods of the invention are useful, for example, as foodstuffs. The methods of the invention are useful, for example, for making the baked goods of the invention.

### DETAILED DESCRIPTION OF THE PREFERRED EMBODIMENT

Unless stated otherwise, all percentages are percentage by weight.

In one aspect, the present invention provides partially waxy wheat flour comprising starch comprising amylose in an amount from at least 10% up to 20%, and amylopectin in an amount less than 90%. The partially waxy wheat flours of this aspect of the invention are not mixtures of different types of flours, but are made from a single type of wheat that produces starch possessing the desired characteristics.

The prime starch fraction of the starch of the partially waxy flours of this aspect of the invention has a Brabender amylograph peak viscosity temperature, and therefore gelatinization temperature, of from 93° C. to 96.5° C. These values are almost as high as the Brabender amylograph peak viscosity temperature for the prime starch fraction of the starch from wheat that does not include any recessive mutant waxy genes. Prime starch is the essentially pure starch fraction, containing only unbroken starch granules, and separated from the principal protein fractions in the flour; it has a very low mineral content and is very low in protein. The prime starch still contains small amounts of phospholipids and a very minor fraction of proteins mostly associated with the starch granules (as are the GBSS enzyme proteins). Prime starch can be isolated, for example, by the method set forth in U.S. Pat. No. 5,439,526 to Czuchajowska et al. Amylographic data are generated by standard techniques set forth in Shuey, W. C. and Tripples, K. H., (eds.) The Amylograph Handbook, 1980, Am. Assoc. Cereal Chem., St. Paul, Minn.

Some partially waxy wheat flours of the invention further comprise protein in an amount of from 5 to 16 weight percent. The protein composition of the flour also affects the texture, consistency and shelf life of the baked goods. See, e.g., Payne, P. I., et al., Phil. Trans. R. Soc. Lond. B 304:359-371 (1984); Shewry, P. R., et al., J. Sci. Food Agric. 73:397-406 (1997). In general, flour useful for making bread requires higher levels of stronger High Molecular Weight (HMW) proteins, such as HMW gluten in proteins, while wheats that yield flours useful for making sponge, cakes and cookies requires lower amounts of weaker strength HMW proteins. Indeed, typically the amount of total protein in flours best adapted for making bread is higher (typically in the range of 11% to 16%) than in flours best adapted for making cakes.

The HMW gluten in proteins interact to provide the properties of mixing strength to glutens, whereas the gliadin proteins contribute to the extensibility of glutens, and both types of proteins interact to provide the strength and elasticity to doughs made from wheat flours. The major gliadin proteins are controlled by homologous gene loci located on the group 6 chromosomes of the A, B, and D genomes of wheats.

Some flours of the present invention include the combinations of HMW proteins set forth in Table 1 (the proteins are identified by numbers and the combinations of specific proteins are set forth in the rows of Table 1):

TABLE 1

| | Genome | | |
|---|---|---|---|
| | A | B | D |
| Bread Wheats | 2 | 17 + 18, 14 + 15 | 5 + 10 |
| | 1 | 17 + 18, 14 + 15 | 5 + 10 |
| | 0 | 17 + 18, 14 + 15 | 5 + 10 |
| Wheat for Making | — | — | 2 + 12 |
| Sponge Cake | — | 6, 6 + 8 | 2 + 12, 0 |
| | — | 6 + 8 | 3 + 12, 0 |
| Common Wheat for | 0 | 7 | 2 + 12, 3 + 12, 4 + 12 |
| Making Cakes and | 0 | 7 + 8 | 2 + 12, 3 + 12, 4 + 12 |
| Cookies | 0 | 6 + 8 | 2 + 12, 3 + 12, 4 + 12 |
| | 0 | 7 + 8, 7 + 9, 6 + 8 | 2.2 + 12 |
| | 0 | 7 + 9 | 2 + 12, 3 + 12, 4 + 12 |

Wheat plants that yield partially waxy flours of the present invention can be produced by any recognized plant breeding method. Grains with one or two missing enzyme proteins will be those that are partially waxy. Proteins at the PAGE gel locations for the A, B, and D genome GBSS enzymes are readily identifiable. The A genome GBSS protein is larger in size, thus appears above the B and D genome proteins in a preparation. Grains able to produce two gene partially waxy wheats will show one GBSS enzyme protein at one of the three genome protein locations on the gels, thus wheat plants carrying two recessive waxy genes, the A-wx, B-wx, partially waxy types will have the D-Wx GBSS enzyme protein present, while those with the A-Wx GBSS protein will be the B-wx, D-wx partial waxy plants. Likewise, grains carrying the B-Wx GBSS enzyme protein will be partially waxy wheats with the A-wx, D-wx recessive alleles. Growing out the plants from the tested grains will allow confirmation of their homozygosity, because the heterozygote with only one of the two GBSS enzyme protein alleles may not be as readily distinguishable without experience in gel analysis. However, the plants grown from the tested seeds identified as partially waxy for two recessive wx loci, will produce only non-waxy grains, if it breeds true, but if the plant produces some grains that are fully waxy, the grain tested was heterozygous for one GBSS protein, hence testing of the non-waxy grains will be required to recover grains for producing partially waxy plants. If a partially waxy wheat is desired with only a single recessive waxy gene, those grains having GBSS proteins at two of the genome protein locations would be selected. Because of uncertainty in the identity of heterozygotes, a similar check of the grains produced on the F2 plant may be required. However, one of ordinary skill in the art will be able to identify heterozygotes from homozygotes, by noting the lower density of the GBSS protein band(s) in the gel(s). Notably, the above method allows the breeder to select partially waxy grains carrying recessive waxy alleles at any one, or a combination, of two recessive alleles in any two of the three genomes of hexaploid wheats.

The presently preferred method for preparing wheat plants that yield partially waxy flours of the present invention is set forth in Example 1 herein. In the method set forth in Example 1, in order to utilize waxy gene sources having the waxy starch trait, but which carry mutant alleles, which produce a detectable, but inactive, or partially active GBSS enzyme protein, the plant carrying the inactive or partially active GBSS protein must be crossed to a plant carrying the null, recessive allele at the locus having the detectable protein, then by electrophoresis, select the grains which carry the inactive, or partially active GBSS protein.

By way of example, amylose, amylopectin and total protein content of the wheat flours of the invention can be determined as described in Example 2 herein. In another embodiment, the present invention provides partially waxy wheat flours of the invention that entirely lack polyphenol oxidase (PPO) activity. Any of the partially waxy wheat flours of the invention described herein can optionally possess no polyphenol oxidase activity. Thus, the present invention also provides flour blends that include a partially waxy wheat flour of the invention that has no polyphenol oxidase activity; and also provides baked goods made from a partially waxy wheat flour of the invention having no polyphenol oxidase activity. Partially waxy wheat flours of the invention that have no polyphenol oxidase activity can be made, for example, by crossing a wheat plant that yields a partially waxy wheat flour of the invention with a wheat plant that yields flour having no polyphenol oxidase activity. Example 3 herein describes creation of a wheat line that produces partially waxy wheat flour having no polyphenol oxidase activity by breeding. Again by way of example, wheat plants that produce partially waxy wheat flour having no polyphenol oxidase activity can be produced by mutagenizing the seeds of a wheat plant that yields partially waxy wheat flour, and screening the resulting progeny for wheat plants that yield partially waxy wheat flour and have no polyphenol oxidase activity. Example 4 herein describes the production, by chemical mutagenesis, of a wheat plant that yields partially waxy wheat flour having no polyphenol oxidase activity.

In another aspect, the present invention provides baked goods prepared from flour of the invention. The flours of the present invention can be used to prepare any baked food that includes wheat flour. By way of non-limiting example, the flours of the present invention can be used to prepare: bread, rolls, raised doughnuts, bagels, steam breads, unleavened bread, flat breads, noodles, chemically leavened bread, biscuits, single layer or multilayer cakes, cookies, and pancakes. Cakes are preferably made from soft wheat flour of the invention, such as soft wheat flour made from wheats with weaker strength HMW proteins (such as, A-0; B-7, 7+8, 6+8, 7+9; and D-2+12, 3+12, 4+12, 2.2+12). In some embodiments, the present invention provides flours that are particularly useful for making sponge, layer or pan cakes using chemical leavening, or sponge cakes in which the cake structural protein matrix is contributed by eggs or egg whites. These partially waxy wheat flours include HMW proteins, such as A-0; B-6+8 or 7+9, D-2+12, or preferably A-0, B-0 or 6; and D-0.

In another aspect, the present invention provides a flour blend comprising partially waxy wheat flour comprising starch comprising amylose in an amount from at least 10% up to 20%, and amylopectin in an amount less than 90%. The flour blends of this aspect of the invention comprise partially waxy wheat flour (comprising starch comprising amylose in an amount from at least 10% up to 20%, and amylopectin in an amount less than 90%) in an amount of at least 50%, in some embodiments in an amount greater than 70%, in other embodiments in an amount greater than 80%, and in some embodiments in an amount greater than 90%. The flour blends can also include fully waxy flour, normal flour, and/or partially waxy flour in addition to partially waxy wheat flour comprising starch comprising amylose in an amount from at least 10% up to 20%, and amylopectin in an amount less than 90%. Some flour blends of this aspect of the invention further comprise protein in an amount of from 5% to 16%.

The present invention also provides baked goods prepared from any partially waxy wheat flour, or flour blend, of the invention. The flours and flour blends of the present invention can be used to prepare any baked good, such as those set forth supra. The preparation of baked goods is well known to those of skill in the art, and is set forth in numerous publications, such as Rombauer, I. S., and Rombauer Becker, M. Joy of Cooking, Bobbs-Merrill Company, Inc. (1974). Library of Congress Cat. No. 61; 7902.

It is a feature of the baked goods of the invention that they possess an extended shelf life. Shelf life is determined by preparing a baked good (such as a loaf of bread) from a flour, or flour blend, of the invention, and storing the baked good under defined conditions (such as at 4° C.) for a desired period of time that simulates storage on a market shelf. The moisture content of the stored, baked, good of the invention is measured at least once (typically once per day over a period of several days) during the storage period and compared to the moisture content of a reference baked good prepared identically to the baked good of the invention, except that the reference baked good is not prepared using a flour, or flour blend, of the invention. The reference baked good is of the same type as the baked good of the invention, e.g., a reference bread loaf is compared with a bread loaf of the invention, and a reference sponge cake is compared with a sponge cake of the invention.

An exemplary method for measuring shelf life of a baked good is set forth in Example 2 herein.

Some embodiments of the baked goods of the invention possess a shelf life that is between 1.0 and 1.5 times longer than the shelf life of the same type of reference baked good. Some embodiments of the baked goods of the invention possess a shelf life that is between 1.5 and 2.0 times longer than the shelf life of the same type of reference baked good. Some embodiments of the baked goods of the invention possess a shelf life that is between 2.0 and 3.0 times longer than the shelf life of the same type of reference baked good.

In another aspect, the present invention provides methods for making baked goods. In one embodiment, the methods comprise the steps of (a) preparing a baking mix comprising flour consisting of partially waxy wheat flour comprising starch comprising amylose in an amount of from 10% to 20% and amylopectin in an amount less than. 90%; and (b) baking the baking mix to form a baked good. In some embodiments, the flour further comprises protein in an amount of from 5% to 16%. Any baking mix of the invention can be used in the practice of the methods of the invention. The precise composition of a baking mix depends on the type of baked good being prepared. Baking recipes and methods are well known in the art and are disclosed, for example, in Rombauer, I. S., supra.

The following examples merely illustrate the best mode now contemplated for practicing the invention, but should not be construed to limit the invention. All literature citations herein are expressly incorporated by reference.

### EXAMPLE 1

This example describes the breeding of wheat plants that yield a flour of the invention that can be used to produce baked goods possessing an extended shelf life.

A fully waxy wheat plant was produced by crossing the Japanese experimental wheat, Kanto 107, which carries the A-wx and B-wx recessive GBSS alleles (referred to as waxy (wx) alleles), with the Chinese Land Race Bai Huo, which carries the D-wx recessive waxy allele. Both Kanto 107 and Bai Huo are hexaploid wheats. The F1 plants were grown, and among the seeds produced from the cross, one among 64 grains were identified as fully waxy, from their ‘opaque’ external appearance. Their waxy nature was confirmed by testing the cut surface of the selected grains with a dilute iodine/potassium iodide (IKI) solution. The test confirmed that the selected grains were fully waxy, by the red-brown stain made on the cut surface, as a result of the reaction of the IKI solution with the starch of the waxy wheat endosperm. Non-waxy, and partially waxy grains stained dark blue, indicative of an amylose starch/IKI reaction.

A plant grown from the waxy grain was then crossed with ID377s, a hard white spring wheat variety, which was known to carry the B-wx recessive waxy allele. The F1 plant from this cross was grown, and as before, waxy grains were selected from among the seeds produced on the F1 plant. The occurrence of the fully waxy grains among the seeds from an F1 plant is due to a phenomenon, called xenia. This phenomenon describes the expression of an endosperm trait controlled by recessive genes via the cereal triploid endosperm. A plant grown from the waxy grain of that F1 was crossed to the hard white spring wheat, Klasic. Klasic also carries the B-wx allele. A plant grown from a waxy grain produced on the latter cross, was then crossed to an NPB selection from ID377s, which carries the B-genome HMW proteins 17+18 (as does Klasic), and grains produced by this cross were analyzed by SDS-PAGE to identify grains carrying the Klasic type HMW proteins, and also by silver stained PAGE electrophoresis to identify grains carrying both the Klasic HMW protein profile, and the combinations of A-wx, B-wx or B-wx D-wx waxy alleles, as grains of partially waxy hard white spring wheat selections.

Plants grown from these selected grains were grown to maturity, and the grains produced by each were screened for the presence of fully waxy individuals, to detect the progeny heterozygous for an A-wx or B-wx gene, indicating that the grain of the selected seed/plant was heterozygous, therefore not true-breeding for the selected partially waxy gene combination. Grains produced on those plants that did not segregate for the fully waxy trait were then identified as partially waxy, and were grown to produce the representative partially waxy wheat lines that yield flour of this invention.

A recheck of the HMW protein profiles of the selected lines was made to confirm that the lines carry HMW proteins A-1, or 2*; B-17+18; and D-5+10. Progeny grown from the selected, tested lines were reselected for other traits, as plant height, disease resistance, grain size, and quality (appearance). The reselections made from each of the partially waxy lines were increased, and grain harvested from those increases were used to evaluate the bread-making properties of these partially waxy lines. Interestingly, it was found that flour and starch from different individual advanced partially waxy lines had amylose contents varying from 15 to 18.5%.

Partially waxy winter wheat lines can be developed by crossing the variety Ike, a HRW wheat, which carries the A-wx and B-wx alleles, with Bai Huo to produce a fully waxy grain, and then make crosses and selections according to the method described above; or cross Ike with a fully waxy grain from the Kanto 107/Bai Huo/Klasic combination to recover fully waxy progeny, which can be used in other crosses, as with NuPlains, HWW (with no waxy genes) to produce partially waxy winter wheat lines by a similar scheme, but in which the parental lines all have winter habit and winter hardiness, as desired.

To develop partially waxy lines with the A-wx D-wx allele combination, the waxy plant from cross 2 are crossed to a plant carrying no recessive wx alleles, such as Blanca Grande, and grains produced by the F1 plant are screened by PAGE electrophoresis for those without the GBSS proteins at the locations of the A-wx, D-wx recessive alleles, but which carry the B-WX dominant allele for the waxy GBSS enzyme protein. Plants grown from grains, so identified, are grown, and their grains checked for the occurrence of fully waxy seeds, and those without waxy grains are grown further to produce A-wx, D-wx partially waxy lines.

While the preferred embodiment of the invention has been illustrated and described, it will be appreciated that various changes can be made therein without departing from the spirit and scope of the invention.

### EXAMPLE 2

This example describes the properties of representative partially waxy wheat flours of the invention. The data discussed in the text is set forth in the tables.

Three, two replicate experiments provide evidence that flour of the invention improves the shelf life of baked goods. In one experiment, flours of the invention produced from partially waxy wheats were made into bread, to study over storage time at low temperature (4° C.), the moisture retention and softness of the breads, which either did or did not include malt.

Prime starch from the two partially waxy flours (No. 15, and No. 16) were found to contain, respectively 15.4% and 18.2% amylose, compared to the control flour, which contained 24.9% amylose. Protein contents of the two experimental flours were 15.14% and 16.70%, while the SDS sedimentation values of the two flours were almost identical, at 60.56 and 60.54. Water absorption of the two experimental flours of the invention for baking bread, was slightly greater than that of the control. Brabender Micro Visco-Amylograph peak viscosity temperatures for the prime starches of the experimental lines of the invention, were essentially equal to that of the prime starch of the control, standard flour.

The bread crumb moisture contents of the two experimental samples at day 1 was similar to that of the control, but after 7 days holding, or storage at 4° C., the moisture content of the crumb of both control and experimentals decreased, but at different rates, and the hardness of the bread crumb of the experimentals was significantly lower, compared to the control, whether the bread was formulated with or without malt. The after-bake storage at 4° C. greatly accelerates the storage process, compared to storage at room temperature or higher, because the lower temperature increases the rate by which the recrystallization/retrogradation of the amylopectin starch molecules in the denatured protein matrix cells of the baked bread crumb.

In trial 1 breads, the malt addition increased the loaf volume of both experimental and controls. Although bread crumb moisture values were not always greater for the experimental breads, the springiness and cohesiveness measurements, made after one day storage at 4° C., were higher for the experimentals, than the control.

In experiment 2, baked breads from the standard flour control and the same two experimental partially waxy wheat flours of the invention were stored for several days at 4° C. following baking, and analyses of bread firmness (hardness) and crumb moisture were made after each day of storage. The breads were baked both with and without malt in their formulations. This experiment clearly demonstrated the superiority of the breads made from the partially waxy wheats of the invention with regard to their longer retention of ‘freshness’ over time, as estimated from the lower firmness values of the experimental breads, and as measured by their slightly higher crumb moisture contents recorded over time of storage at low temperature. The regression lines for these parameters measured over time indicate that the experimental breads retained freshness at about 1.4-1.5 times that of the controls. Translated into storage at a higher temperature, as would be the case for a bakery or grocery store shelf, the freshness retention would be far greater, since the rate of staling accelerates at 4° C.

Analyses of the prime starch separated from the partial waxy wheat lines, representative of the invention, demonstrated that the partial waxy wheat starches from the wheat selections having flour protein contents of 15.14 and 16.70 percent respectively, had prime starch Brabender Micro Visco-Amylograph peak viscosity temperature values averaging 96.25° C., essentially equal to the Brabender Amylograph peak viscosity temperature of the control prime starch, which was 95.8° C. The amylose content of the prime starch of line HWSW98018-68-1 (sample 15) was 15.4%, while that of line HWSW98017-15 (sample 16), was 18.2%. The control flour protein content was 15.3%, and the control prime starch had an amylose content of 24.85%.

The physical/chemical characteristics of the prime starches of the experimental lines, compared to the control prime starch were measured via the viscosity values at the Brabender Micro Visco-Amylograph. The starch (5 g, in 100 ml water), was heated to 95° C., and held at 95° C. for 5 minutes (start of holding), then cooled to 50° C. at 7.5° C./min, over a period of 6 min. During the heating, holding, and cooling of the starch in the Babender Micro Visco-Amylograph, the viscosity of the starch paste was measured. The peak viscosity, was the maximum viscosity value of the starch paste during heating or holding at 95° C. Breakdown viscosity was the decrease of viscosity value from the peak viscosity value during the holding period at 95° C. Setback viscosity was the increased viscosity value during cooling of the starch paste, from the viscosity value at the end of the holding the starch paste at 95° C. Breakdown viscosity values for the partially waxy lines were greater than for the control, confirming that the pastes of the partially waxy prime starches had a higher amylopectin content, than the control prime starch. Measurements of the paste viscosities of the partially waxy prime starches at the Brabender Micro Visco-Amylograph showed that the maximum viscosity for No. 15 prime starch averaged 445, and that for No. 16, was 425, while that for the control prime starch was 182, significantly lower, indicative of the influence of the higher proportion of amylopectin in the prime starches of the partially waxy lines. At the start of the holding period at 95° C., the viscosity of No. 15 averaged 351.5, and was 252 five minutes later, at the start of the cooling (to 50° C.) period. At the end of the cooling period, the paste viscosity of No. 15 was 539. The breakdown value for No. 15 was 193. Viscosity values for test lot No. 16 averaged 320, at the start of the holding period, and at the start of the cooling period were 250.5, while at the end of the cooling period, the viscosity was 549, while the breakdown viscosity value was 178. Comparable Brabender Micro Visco-Amylograph viscosity changes for the control prime starch paste were: Peak viscosity 182, viscosity at the start of the holding period; 143; viscosity at the start of the cooling period: 134; viscosity at end of cooling period: 289; while the breakdown value was 48. Thus, the experimental partially waxy lines had much higher peak viscosity values and much higher breakdown viscosity values. The high setback values for the partially waxy lines may relate to cooking the starch too fast.

The viscosity changes of the pastes made from the prime starch fractions of the two experimental lines illustrate the influence of the waxy genes on the properties of the flours are indicative of the moisture retention capacities of the partially waxy starches. Similarly, the breakdown viscosity of the control prime starch paste was much lower than that measured for the partially waxy wheat prime starch pastes. The measurements of the viscosity values for the prime starch pastes of the partially waxy lines reflect the presence of the increased levels of amylopectin molecules in the prime starches of the partially waxy wheat flours. In contrast, the Brabender Micro Visco-Amylograph peak viscosity of the control prime starch at 182, was markedly lower, as was the viscosity of the control prime starch paste at the start and end of the holding period, and at the start and end of the cooling period. The control prime starch breakdown viscosity was lower than the breakdown viscosities of the partially waxy starch pastes, and the viscosity values did not increase as much by the control starch as were noted for the partially waxy prime starches, indicative of the greater stability of the pastes made from the partially waxy prime starches. Similarly, the breakdown viscosity of the control prime starch was much lower than measured for the partially waxy starch pastes. The measurements of the viscosity values for the prime starches of the partially waxy starches reflect the presence of the increased levels of amylopectin molecules in the prime starches of the partially waxy flours.

In another study, conducted by a commercial food products company, bagels were made from the partially waxy flours and the texture of the bagels were measured after 1 day of storage at room temperature, compared with measurements of bagels made from control flour. The measurements are presented as averages made of 4 test samples (replicates). The measurements were of: hardness, cohesiveness and springiness of 1 day old bagels. The hardness value for the control bagels was 1875, while that of the bagels made with the partially waxy flour was 1000. However, bagels made from a 50:50 mixture of control flour with the partially waxy flour had a hardness value of 800, both significantly lower than the control bagels, certainly reflecting the influence of the increased proportion of amylopectin starch in the flour or blended flours from which the bagels were made. Similarly, the bagels made from the partially waxy flour and blend of the partially waxy flour and control flour had higher cohesiveness values. Likewise, the springiness measurements showed that the bagels made from the partially waxy flour and from the blend, were notably more springy after 1 day's storage at room temperature than for the bagels made from the control flour. The results clearly showed that bagels made from the partially waxy flour, and the blend of control and partially waxy flour were significantly fresher than those made from the control flour. Of interest also were the measurements of bagel hardness, cohesiveness and springyness made on the day the bagels were made. The values for hardness showed that the bagels made from partially waxy wheat flour and from the blend of partially waxy wheat flour and control flour were significantly softer than those made from the control flour. Measurements of cohesiveness and springiness were likewise greater for the bagels made from the partially waxy wheat flour or the blend of the control and partially waxy wheat flours. These values again reflect the influence of the increased proportion of amylopectin starch in the partially waxy wheat flour and show that the influence of the increased amylopectin starch is reflected even via the proportion of amylopectin starch present in the blended flours.

Differential scanning calorimetry (DSC) measurements on the bagels after 1 day storage showed that the bagels made from the partially waxy wheat flour and the blended flours had lower amounts of retrograded starch, as estimated from the onset temperature, peak temperature and Delta H values, all of which illustrate the greater freshness of the bagels made from the partially waxy wheat flour or the blended partially waxy and control flours. Likewise, measurements of free-water ice crystal melting temperatures for the bagels made from the partially waxy and blended flours indicated that the increased levels of amylopectin starch in the flours may be responsible for the apparently greater freshness of the bagels made from the partially waxy flour and from the blend of the partially waxy and control flours.

TABLE 2
Properties of Flour and Prime Starch from Partially Waxy Wheat
Accession Lines HWSW98081C-58-1 (Lab No. 15) and HWSW98017-
15 (Lab No. 16). The values reported are on a dry weight basis.

| Test | Results | Lab 15# | Lab 16# | Control |
|---|---|---|---|---|
| Flour | Moisture | 13.8 | 13.9 | 15.33 |
| | Ash | 0.493 | 0.456 | 0.418 |
| | Protein | 15.14 | 16.7 | 15.3 |
| | Abs. | 67 | 69 | 68 |
| | Mix. Time | 3:30 | 3:15 | 4.15 |
| | SDS as-is | 60.56 | 60.54 | 53 |
| Bradender | Protein | 0.211 | 0.204 | 0.30 |
| Micro Visco- | Ash | 0.17 | 0.154 | 0.15 |
| Amylo-Graph | Amylose | 15.4 | 18.2 | 24.85 |
| Prime Starch | Peak Temperature | 96.25 | 96.25 | 95.8 |
| | Max Viscosity | 445 | 425 | 182 |
| | Viscosity/Hold. Peri | 350.5 | 320 | 143 |
| | Viscosity Start Cooling | | | |
| | Viscosity/End Cooling | 252 | 250.5 | 134 |
| | Period | | | |
| | Breakdown Viscosity | 539 | 549 | 289 |
| | Setback Viscosity | 193 | 174.5 | 48 |
| | | 287 | 298.5 | 155 |

TABLE 3
Intermental Texture Profile Analysis of Fresh Baked Bagels.
The bagels were baked and tested on the same day.
All Trumps is a non-waxy wheat flour. Partially waxy
wheat flour No. 15 was utilized in these experiments.

| | | | Cohesiveness | Springiness |
|---|---|---|---|---|
| Sample ID | | Hardness (g) | (A2/A1) | (mm) |
| All Trumps | 1 | 1125 | 0.513 | 13.7 |
| | 2 | 1090 | | |
| | 3 | 1340 | 0.52 | 13.9 |
| | 4 | 1345 | 0.501 | 12.8 |
| | Avg | 1225 | 0.511 | 13.5 |
| 50% All Trumps | 1 | 495 | 0.643 | 13.1 |
| 50% Partial Waxy | 2 | 605 | 0.643 | 15.6 |
| | 3 | 585 | 0.637 | 15.2 |
| | 4 | 525 | 0.668 | 15.5 |
| | Avg | 553 | 0.648 | 14.85 |
| Partial Waxy | 1 | 560 | 0.704 | 15.9 |
| | 2 | 575 | 0.679 | |
| | 3 | 575 | | |
| | 4 | 735 | 6.53 | 14 |
| | Avg | 611 | 2.638 | 14.95 |

TABLE 4
Intermental Texture Profile Analysis of Fresh Baked Bagels.
The bagels were tested one day after baking. Partially waxy
wheat flour No. 15 was utilized in these experiments.

| | | | Cohesiveness | Springiness |
|---|---|---|---|---|
| Sample ID | | Hardness (g) | (A2/A1) | (mm) |
| All Trumps | 1 | 2175 | 0.268 | 7.2 |
| | 2 | 2260 | 0.262 | 7.2 |
| | 3 | 1645 | 0.27 | 7.4 |
| | 4 | 1420 | 0.347 | 10.8 |
| | Avg | 1875 | 0.287 | 8.2 |
| 50% All Trumps | 1 | 740 | 0.293 | 11.2 |
| 50% Partial Waxy | 2 | 740 | 0.298 | 10.2 |
| | 3 | 960 | 0.303 | 9.6 |
| | 4 | 990 | 0.325 | 9.1 |
| | Avg | 858 | 0.305 | 10.03 |
| Partial Waxy | 1 | 900 | 0.339 | 9.8 |
| | 2 | 1055 | 0.331 | 9.7 |
| | 3 | 1020 | 0.281 | 9.1 |
| | 4 | 1025 | 0.319 | 10.3 |
| | Avg | 1000 | 0.318 | 9.73 |

TABLE 5
Differential Scanning Calorimetry Analysis of Fresh, One Day
Old, and Four Day Old Bagels. Partially waxy wheat flour
Sample No. 15 was utilized in these experiments. These
experiments demonstrate the effect of waxy wheats
on starch retrogradation rates.
Retrograded Starch Peak

| | | Onset | Peak | Delta | Onset |
|---|---|---|---|---|---|
| | | T (C) | T (C) | H (J/g) | T (C) |
| Fresh | 100% All Trumps | Peak Not Detected | | | −9.4 |
| Fresh | 50% AT/50% Part Waxy | Peak Not Detected | | | −10.1 |
| Fresh | 100% Partial Waxy | Peak Not Detected | | | −10.6 |
| 1 Day Old | 100% All Trumps | 50.6 | 65.2 | 0.62 | −10 |
| 1 Day Old | 50% AT/50% Part Waxy | 47.6 | 62.4 | 0.93 | −9 |
| 1 Day Old | 100% Partial Waxy | 48.2 | 63.6 | 0.87 | −9.4 |
| 4 Days | 100% All Trumps | 54.2 | 66.6 | 1.1 | −11.5 |
| 4 Days | 50% AT/50% Part Waxy | 60.8 | 75.2 | 1.24 | −12.6 |
| 4 Days | 100% Partial Waxy | 57.4 | 71 | 1.14 | −11.4 |

TABLE 6
Texture Attributes, Day 1. Partially waxy wheat flour Sample
No. 15 was utilized in these experiments.

| | | 50% All | |
|---|---|---|---|
| | All Trumps | Trumps, 50% | 100% |
| | Control | HWSW | HWSW |
| FIRST CHEW (MOLARS) | | | |
| Initial Moistness | 2.6 | 2.9 | 3.1 |
| Hardness | 4.8 | 4.9 | 5 |
| Cohesiveness | 7.9 | 8.8 | 9.6 |
| CHEWDOWN (7-10 CHEWS) | | | |
| Mass Cohesiveness | 9.9 | 9.8 | 8.4 |
| Dissolvability | 3.6 | 3.7 | 3.6 |

TABLE 7
Texture Attributes, Day 2. Partially waxy wheat flour Sample
No. 15 was utilized in these experiments. With respect to
Tables 5 and 6, differences in mean scores between products
of 0.5 or greater may be considered meaningful. Multiple
differences of less than 0.5 may also be considered meaningful.

| | | 50% All | |
|---|---|---|---|
| | All Trumps | Trumps, 50% | 100% |
| | Control | HWSW | HWSW |
| FIRST CHEW (MOLARS) | | | |
| Initial Moistness | 2.3 | 2.6 | 1.8 |
| Hardness | 5.3 | 5 | 5.5 |
| Cohesiveness | 8.1 | 9 | 9.2 |
| CHEWDOWN (7-10 CHEWS) | | | |
| Mass Cohesiveness | 9.9 | 9.3 | 9.5 |
| Dissolvability | 4.2 | 4.2 | 4.3 |

TABLE 8
Properties of Bread (with malt and/or without malt) Made from
Partially Waxy Wheat Accession Nos. HWSW98081C-58-1
(Lab Sample No. BD15) and HWSW98017-15 (Lab Sample
No. AB16). Control is bread with malt and/or without
malt made from non-waxy bread flour.

| Bread w/ | | Firm- | Mois- | Bread w/o | | Firm- | Mois- |
|---|---|---|---|---|---|---|---|
| Malt Time | Flour | ness | ture | Malt Time | Flour | ness | ture |
| Day 1 | Control | 2.48 | 42.6 | Day 1 | Control | 2.10 | 42.8 |
| | BD15 | 1.33 | 44.4 | | BD15 | 1.15 | 43.1 |
| | AB16 | 1.56 | 45.0 | | AB16 | 1.05 | 73.3 |
| Day 2 | Control | 3.71 | 40.7 | Day 2 | Control | 3.76 | 41.8 |
| | BD15 | 1.82 | 41.4 | | BD15 | 2.44 | 43.3 |
| | AB16 | 1.82 | 43.4 | | AB16 | 2.04 | 40.9 |
| Day 3 | Control | 4.60 | 39.0 | Day 3 | Control | 3.81 | 40.3 |
| | BD15 | 3.24 | 39.2 | | BD15 | 3.08 | 42.2 |
| | AB16 | 2.85 | 42.2 | | AB16 | 2.31 | 42.8 |
| Day 4 | Control | 4.71 | 35.9 | Day 4 | Control | 5.23 | 40.8 |
| | BD15 | 3.33 | 39.1 | | BD15 | 3.70 | 41.1 |
| | AB16 | 2.83 | 40.0 | | AB16 | 3.33 | 42.3 |
| Day 5 | Control | 5.32 | 38.9 | Day 5 | Control | 5.45 | 40.0 |
| | BD15 | 3.03 | 38.8 | | BD15 | 3.92 | 40.4 |
| | AB16 | 3.21 | 38.4 | | AB16 | 3.54 | 42.2 |
| Day 6 | Control | 5.83 | 35.3 | Day 6 | Control | 6.09 | 37.9 |
| | BD15 | 3.60 | 36.2 | | BD15 | 4.33 | 38.1 |
| | AB16 | 3.51 | 38.9 | | AB16 | 3.87 | 38.4 |

TABLE 9
This Table Shows Data Obtained From a Repeat of
the Experiment Described in Table 8.

| | | | | | | | |
|---|---|---|---|---|---|---|---|
| | | Bread | | Water | Firm- | Mois- | Springi- |
| Time | Flour | Wt. | Volume | Activity | ness | ture | ness |

Bread w/o Malt

| | | | | | | | |
|---|---|---|---|---|---|---|---|
| Day 1 | Control | 153.62 | 890 | 0.976 | 2.059 | 43.96 | |
| | BD15 | 149.75 | 970 | 0.973 | 0.978 | 44.29 | |
| | AB16 | 156.71 | 960 | 0.973 | 0.889 | 45.49 | |
| 9 Days @ | Control | | | 0.975 | 5.700 | 37.92 | 0.890 |
| 4° C. | BD15 | | | 0.966 | 5.920 | 36.31 | 0.897 |
| Jul. 7, | AB16 | | | 0.962 | 4.065 | 39.10 | 0.922 |
| 2000 | | | | | | | |

Bread with Malt

| | | | | | |
|---|---|---|---|---|---|
| Day 1 | Control | 151.63 | 910 | 2.05 | 44.41 |
| | BD15 | 148.34 | 1007 | 0.94 | 43.41 |
| | AB16 | 151.68 | 1000 | 0.92 | 44.62 |
| 7 Days | Control | | | 5.84 | 37.08 |
| | BD15 | | | 4.34 | 36.48 |
| | AB16 | | | 4.04 | 37.13 |

### EXAMPLE 3

This experiment describes the breeding of wheat plants that yield partially waxy wheat flour having no polyphenol oxidase activity.

A parent line was attained which was a recombinant from a cross between an artificially synthesized common wheat, derived from a chromosome-doubled F1 hybrid between a durum wheat variety (genomes A, B), which had the zero PPO trait, and a selection of Aegilops squarrosa (genome D), which also possessed the zero PPO trait This synthetic wheat (given Canadian accession No. RL5710) was crossed, and the F1 back crossed, with a Canadian line designated Alpha 16. The Alpha 16*²\RL5710 line was crossed with the progeny of a cross between ID377S, and a fully waxy line from the cross Kanto 107\Bai Huo. A fully waxy line from that cross was used as a parent to cross with the line derived from the cross Klasic\ID377s, and the resulting F1 was crossed to the Alpha 16*²\RL5710 accession.

Progeny from this cross were selected that possessed the zero PPO trait. Selection for the zero PPO trait can be done using any art-recognized method, such as the method disclosed by Andersen, J. V., and Morris, C. F., Crop Science 41: 1697-1705 (2001), or by Bernier, A. M., and Howes, N. K., Journal of Cereal Science 19:157-159 (1994).

### EXAMPLE 4

This example describes the production of wheat plants that yield partially waxy wheat flour having no polyphenol oxidase activity by chemical mutagenization of wheat seeds.

A cross was made between wheat variety Klasic and between variety ID377s, and the resulting wheat line was called SR669-1p. Bulk M3 seeds from SR669-1p were screened for low PPO activity, and about 30 seeds having low PPO activity were identified. Plants were grown from the selected seeds and 13 of the plants had the desired zero PPO trait.

While the preferred embodiment of the invention has been illustrated and described, it will be appreciated that various changes can be made therein without departing from the spirit and scope of the invention.

1. A partially waxy wheat flour comprising starch, said starch comprising amylose in an amount of from 10 weight percent to 20 weight percent, and amylopectin in an amount less than 90 weight percent.

2. A partially waxy wheat flour of claim 1 comprising starch comprising amylose in an amount of from 15 weight percent to 20 weight percent, and amylopectin in an amount from 80 weight percent to 85 weight percent.

3. A partially waxy wheat flour of claim 1 comprising starch comprising amylose in an amount of from 15 weight percent to 18 weight percent, and amylopectin in an amount from 82 weight percent to 85 weight percent.

4. A partially waxy hard wheat flour of claim 1 further comprising protein in an amount of from 11 weight percent to 18 weight percent.

5. A partially waxy soft wheat flour of claim 1 further comprising protein in an amount of from 8 weight percent to 12 weight percent.

6. A baked good prepared from partially waxy wheat flour comprising amylose in an amount of from 10 weight percent to 20 weight percent, and amylopectin in an amount less than 90 weight percent.

7. A baked good of claim 6 wherein said partially waxy wheat flour comprises amylose in an amount of from 15 weight percent to 20 weight percent, and amylopectin in an amount from 80 weight percent to 85 weight percent.

8. A baked good of claim 6 wherein said partially waxy wheat flour comprises amylose in an amount of from 15 weight percent to 18 weight percent, and amylopectin in an amount from 82 weight percent to 85 weight percent.

9. A baked good of claim 6 wherein said partially waxy wheat flour further comprises yeast and protein, said protein being present in an amount of from 5 weight percent to 16 weight percent.

10. A baked good of claim 9 wherein said protein is present in an amount of from 8 weight percent to 12 weight percent.

11. A baked good of claim 6 wherein said baked good is bread.

12. A baked good of claim 6 wherein said baked good is cake.

13. A flour blend comprising partially waxy wheat flour, wherein said partially waxy wheat flour comprises starch comprising amylose in an amount greater than 10 weight percent.

14. A flour blend of claim 13 further comprising protein in an amount of from 5 weight percent to 16 weight percent.

15. A baked good prepared from a flour blend comprising partially waxy wheat flour, wherein said partially waxy wheat flour comprises starch comprising amylose in an amount greater than 10 weight percent.
